(19) United States
(12) Patent Application Publication
(10) Pub. No.: US 2003/0030025 A1
(43) Pub. Date: Feb. 13, 2003

(54) Dry chemical powder for extinguishing fires

(76) Inventor: Joseph Michael Bennett, Dayton, OH (US)

Correspondence Address: Joseph Michael Bennett, 5722 Craigmont Court, Dayton, OH, 45424, US

(21) Appl. No.: 10/214,497

(22) Filed: Aug. 8, 2002

Related U.S. Application Data
(60) Provisional application No. 60/382,398, filed on May 21, 2002.
(60) Provisional application No. 60/311,153, filed on Aug. 9, 2001.

(51) Int. Cl. A62C 2/00; A62D 1/00

(52) U.S. Cl. 252/6

(57) ABSTRACT

The present invention relates to improvements to dry chemicals and other fire extinguishing chemicals, to improve their efficiency and performance by improving their ability to absorb thermal radiation from a fire, to reduce heat reflection back to the fire, vaporize and decompose the extinguishant and enhance its breakdown into chemically reactive products. These improvements may include changing the visible color of the particle to increase its thermal radiation absorptivity, or by use of additive particles that can change the dry or wet chemical's radiative absorption properties, or locally react exothermically to increase local temperature and decomposition of the dry or wet chemical particles.

This application claims the benefit of provisional patent applications 60/311,153, Aug. 9, 2001, and 60/382,398, May 21, 2002.

### BACKGROUND OF THE INVENTION

1. Field of the Invention

The present invention relates to a fire extinguishing chemical. More specifically, the present invention relates to improvements to dry chemicals and other fire extinguishing chemicals, to improve their efficiency and performance by improving their ability to absorb thermal radiation from a fire, to reduce heat reflection back to the fire, vaporize and decompose the extinguishant and enhance its breakdown into chemically reactive products. These improvements may include changing the visible color of the particle to increase its thermal radiation absorptivity, or by use of additive particles that can change the dry or wet chemical's radiative absorption properties, or locally react exothermically to increase local temperature and decomposition of the dry or wet chemical particles.

2. Related Art

Dry chemicals and other extinguishing chemicals have been enhanced by numerous means over the years. In the field of dry chemicals, the patent literature alone reveals numerous techniques of enhancement to improve their performance. They include adding new chemically-active additives to the dry chemical particles (U.S. Pat. Nos. 5,393,437 and 5,132,030), forming powders from reacting blends of liquids or gases (U.S. Pat. Nos. 5,938,969, 5,588,493 and 5,091,097), gelling hydrocarbons or other pressurized liquids with powders (U.S. Pat. Nos. 5,833,874 and 4,652,383), blending dry chemicals with aqueous foams (U.S. Pat. No. 5,275,243), substances used to gel a burning fuel when it is applied with a powder (U.S. Pat. No. 5,053,147), materials in powders used to form a glaze over the burning surface (U.S. Pat. No. 4,194,979), and materials mixed into solid propellant gas generators to heat them, generate them and/or discharge them as particulates (U.S. Pat. Nos. 6,217,788, 6,019,177 and 5,609,210).

With all these various techniques of improving the performance of such dry chemicals, there has been no means observed in the literature of improving such performance by controlling the extinguishant's interaction with the thermal radiation emitted from a fire. Fires, and in particular liquid fuel pool fires of interest, have multiple simultaneous mechanisms occurring, which in turn sustain the fire and dissipate its thermal energy. One of the key, but most misunderstood mechanisms is thermal radiation. Thermal radiation released by the reaction zone in the fire transports heat to the liquid pool below, to promote vaporization and the introduction of fuel vapor into the reaction zone to sustain the fire. Since radiation is released in all directions (omnidirectional), it also radiates heat away from the fuel and the fire. This loss of heat must be replaced by the exothermic chemical reactions in the reaction zone to maintain sufficient heat to support and sustain the rate of chemical reaction. The book Principles of Fire Protection Chemistry, Second Edition (Raymond Friedman, November 1989, National Fire Protection Association) discusses this phenomenon to a limited degree. In pp. 82-86, in a section entitled “Radiation from Flames”, it is shown that radiation is the primary means of providing energy feedback to continue to vaporize the fuel, and thus the rate of burning, as well as the spread of fire to nearby combustibles. It is stated that if there is a “cooler smoke or fog droplets” between the flame and its (combustible) target, it will reduce the intensity of the radiation on the target. It is also shown in Table 6.5 and Figure 6.11 in this citation that the percentage of heat lost due to radiation varies between 9% and 43%, with liquid fuels of interest near the higher end. It is stated on page 85 that “loss of heat by radiation causes a lower temperature in the flame, which slows down the chemical oxidation reactions”, which obviously supports the goal of weakening or extinguishing the fire. Only limited data is available on radiation effects as they pertain to fire, due to the complexities of analyzing and calculating the direction and extent of heat losses, their deposition on surrounding structures (dependent on their spatial location relative to the fire) and their re-radiation back to the fire, radiation losses and generation within the surrounding hot air itself, and the respective rates of radiation emittance, absorption and reflection from each of the constituents. Most research has focused on the radiation-based heat deposition on surrounding combustible structures (such as walls and curtains), and the minimum radiative heat flux required to result in their ignition and sustained fire. This mechanism can result in the spread of the fire to these surrounding structures from the original site of the fire, and can lead to a runaway fire spread condition that is beyond the means of fire personnel or fire extinguishing equipment to control and eventually vanquish.

Radiation also affects the performance of dry chemical fire extinguishing particles when they are introduced into the fire region. Such particles can be a sink for the heat released by the fire, to cool it below its sustainment temperature. Chemically reactive dry chemicals, such as sodium and potassium bicarbonate, also decompose when exposed to heat, to release carbon dioxide and metal ions to interrupt the fire reaction chemically as well as smother it. In the previously cited book by Friedman, on pages 190-192, in a section entitled “Dry Chemical Agents”, it is stated on page 191 that “the effectiveness of any of these agents depends on the particle size. The smaller the particles, the less agent is needed as long as particles are larger than a critical size (Ewing et al., 1975). The reason for this fact is believed to be that the agent must vaporize rapidly in the flame to be effective (Iya et al., 1975). However, if extremely fine agent were used, it would be difficult to disperse and apply to the fire.” On page 192, it discusses the high performance of a dry chemical marketed under the name “Monnex”, due to its ability to decompose, “causing a breakup of the particles in the flame to form very fine fragments, which then gasify rapidly.” It also states that “it seems clear that the effective powders act on a flame by some chemical mechanism, presumably forming volatile species that react with hydrogen atoms or hydroxyl radicals.”

Unfortunately, dry chemicals commonly in use typically are white or near-white in visible color. This state results in a high degree of heat reflection from each particle (like little mirrors) back to the fire zone or to the liquid fuel source, and minimal heat absorption by the particles themselves. This promotes the robustness of the fire, and slows the rate of decomposition of the particles themselves, reducing the rate of heat extraction from the fire, and the generation of fire-inhibiting decomposition products to mix into the reaction zone. As a result, particles in the region above or near the fire zone may not break down (and are thus of very little effectiveness), and will deposit in the air or surrounding area.

If the dry chemical particles could be modified, either on their outer surface only or through their thickness, such that they absorbed a greater degree of the thermal radiation, less heat would be reflected back to the fire to maintain the fire, the particles would decompose faster to release their chemical ions and decomposition products to chemically interrupt the fire to a greater degree, and even particles some distance from the fire zone might be of service by extracting additional heat from the fire, and possibly prevent the ignition of surrounding combustible materials by reducing the transmission of infrared radiation from the fire to them. If the dry chemical particles were changed to a color more conducive to thermal radiation absorption (with less reflectivity), such as a flat black, then this desired behavior would be greatly enhanced. The book Fundamentals of Heat and Mass Transfer, Third Edition (Incropera and DeWitt, John Wiley & Sons, Inc., 1981) discusses the effects of surface color on radiative absorption in the chapter entitled “Radiation: Processes and Properties” (pp. 695-749). FIG. 12.23 on page 725 shows the coefficients of absorptivity and reflectivity for various material surface types and colors. For opaque materials, the sum of the coefficients of absorptivity and reflectivity equal one; a highly absorptive surface is correspondingly less reflective, and vice versa. One can see that the curve corresponding to the reflectivity (at a given wavelength) of “white paint” surfaces shows that as high as 90% of radiative energy at wavelengths at or below 1 micrometer is reflected, with only 10% absorbed, and at least 80% is reflected at wavelengths up to 2 micrometers. In comparison, “black paint” surfaces consistently absorb about 97% or more across the wavelengths, and reflect only about 3%. If one uses the Table 12.1 in the same reference, one can determine the percent of total emissive power released from a flame at a given temperature, up to a given wavelength. For a flame temperature of 1273 K (common for a pool fire), about 12% of the total emissive power is released below 1 micrometer in wavelength, where “white paint” surfaces reflects 80% of such energy, and “black paint” surfaces reflect around 3% or less. At wavelengths even as high as 5 micrometers, where up to 75% of the total radiative energy is released, “white paint” surfaces reflect about 12%, which is at least 4-6 times the 2%-3% reflected by “black paint” surfaces. As such, black surfaces will absorb versus reflect a substantially larger portion of the radiation released by a flame. Such particles will extract heat from the fire zone much more efficiently, and decompose much more rapidly, much like particles of much smaller size, while maintaining favorable “throw” characteristics of larger particles during discharge. They will inhibit the transport of heat to the liquid fuel source, and break down in areas farther from the center of the reaction zone, to create a more concentrated cloud of metal ions and inert gas molecules induced into the fire. Such particles will thus replicate the well-known combustion-inhibiting behavior of soot particles, which deprive reaction zones of the heat they need to sustain efficient combustion, such as in engines. Unfortunately, soot particles are carbon-based, which can react exothermically and add heat to the fire in some cases. With this concept, a non-combusting (in fact, combustion-inhibiting) material would exhibit this radiative heat-extraction behavior—the best of both worlds.

As a result, any means that could improve the thermal absorptivity of the particles would “supercharge” the performance of dry chemical fire extinguishants, in a manner than adds negligible cost and complexity. The goal would be to improve the firefighting performance of dry chemical extinguishants, pound for pound, sufficient to increase their AB rating (the size of a liquid fuel pool fire or textile material that can be extinguished) for a given charge of dry chemical and extinguisher size. This same principle could also possibly be applied to non-solid liquid droplets, to assist them in absorbing heat and vaporizing (and thereby absorbing latent heat of vaporization better), and perform in a manner similar to smaller droplets while having the improved “throw” characteristics of larger droplets.

U.S. Pat. No. 6,065,545 (Williams) discloses a method of extinguishing fires in which multiple extinguishing materials are used, in particular dry chemicals and foaming agents. The foaming agents reduce heat from the fire and additional spread of the fire, whereas the dry chemical is effective in interrupting the chemical reactions supporting the fire and thereby working to completely extinguish the fire. When used in this dual-mode manner, the dry chemical is released alongside, or directly inside the stream of the foaming agent delivery system, during a critical period of the extinguishing process. Unfortunately, it is difficult for the operator to observe when the dry chemical is actually discharged, and where it actually is discharged, to confirm that it is delivered to all critical areas of the fire. This difficulty in observing the dry chemical discharge is due to the fact that the dry chemicals are typically colors that blend in with the tint of the stream itself, and do not stand out from the foam stream color. Therefore, it was recommended by Williams to change the color of the dry chemical to make it “vivid” and therefore easier for the operator to see when it is discharged. However, it was not disclosed to change the appearance of the dry chemical in a manner to improve the thermal radiation absorptivity of the powder itself, or any manner of improving the performance of the dry chemical itself; rather, just merely improving its visibility to the human eye and thus the directional discharge ability of delivering the product to the fire. In fact, the “vivid” colors recommended to improve its visibility will likely in most cases increase the reflectivity of the thermal radiation from the powder surface back to the fire. This patent was the only reference in the literature found that proposed any means of changing the color of a dry chemical powder for any purpose during the extinguishing process. It is already well known to those skilled in the art that potassium bicarbonate (Purple K) has been historically tinted with additional purple pigment particles, simply to distinguish it from sodium bicarbonate so that it might not be mistaken for it in storage and during filling and charging operations.

In summary, it is desired to provide a surface modification treatment that improves the ability of a dry chemical to reduce it reflectance of thermal radiation back to the fire. It is also desired to have the dry chemical powder decompose more rapidly to release its chemically active decomposition products. It is also desired to have the dry chemical powder reduce the amount of thermal radiation that passes from the fire to nearby combustible materials. It is also desired to have a dry chemical material that inhibits fires even when discharged some distance from the reaction zone of the fire, rather than simply settle out unused on surfaces nearby. It is also desired to use a means to provide the previously listed desired benefits that can also be applied to liquid droplets. It is also desired to provide alternative treatments to improve the thermal-absorptive ability of dry chemical particles, for reasons previously cited, but in a manner that does not add notable cost, as is possible with the application of dyes or other colorants. No technique has been demonstrated that incorporates these features previously.

### SUMMARY OF THE INVENTION

The principal object of the present invention is to provide a surface modification treatment that improves the ability of a dry chemical to reduce it reflectance of thermal radiation back to the fire.

Another object of the present invention is provide a treatment to a dry chemical fire extinguishing powder to help it decompose more rapidly to release its chemically active decomposition products to improve its ability to extinguish fires.

Another object of the invention is to provide a treatment to a dry chemical powder to help it reduce the amount of thermal radiation that passes from the fire to nearby combustible materials.

Another object of the invention is to provide a treatment to a dry chemical material that inhibits fires even when discharged some distance from the reaction zone of the fire, rather than simply settle out unused on surfaces nearby.

Another object of the invention is to provide a treatment that can provide the previously listed desired benefits that can also be applied to liquid droplets.

Another object of the invention is to provide the preceding enhancements in a manner that does not add excessive cost.

The foregoing objects can be accomplished by applying a treatment to the dry chemical particles, such as dyeing or coating the particles, to produce a surface color (such as flat black) that improves its ability to absorb thermal radiation, rather than reflect it. This process will facilitate the transmission of thermal radiation from the fire into the particle interior at a greater rate, thereby heating it and melting it, and releasing a greater concentration of chemically-active species into the fire's reaction zone as a result, rather than settling out unused or requiring too long a decomposition time to have effect in rapidly extinguishing the fire. This increased radiation and heat absorption will accordingly reduce the amount of thermal radiation reflected back to the fire, thereby depriving it of additional sustaining heat. Even particles some distance from the fire will assist in absorbing heat, and prevent the transmittal of radiation to surrounding combustible structure to inhibit the ignition and spread of fire to other nearby materials. This process can be applied to dry chemicals at minimal cost and therefore provide a more affordable alternative with a more efficient powder material that has economic advantages. This technique could also be applied to extinguishing liquids that are released as small droplets or a mist. If the coloration process adds unacceptable cost, or for other performance or cleanup reasons, the foregoing objects can also be accomplished by adding additional particles of low cost, such as iron oxide, that can adhere to the dry chemical particles, and absorb radiative heat and conduct it to the dry chemical particle. Other low-cost additive particles may already feature the desired coloration, such as activated charcoal, which may provide an overall color conducive to absorption, adhere to the dry chemical particle's surface or leave colored residue on the adjacent dry chemical particles, to improve the absorption of heat into the particles. Such added particles may also react exothermically in the fire zone's heat, further heating the region around surrounding dry chemical particles to assist in their beneficial decomposition to chemically active species. These enhanced design features can satisfy all of the objects stated previously, whereas prior art cannot satisfy all of the objects in their entirety.

### BRIEF DESCRIPTION OF THE DRAWINGS

FIG. 1 is a cutaway view of a dry chemical particle or liquid droplet with a dye applied to its outer surface.

FIG. 2 is a cutaway view of a dry chemical particle or liquid droplet with a coating applied to its outer surface.

FIG. 3 is a cutaway view of a dry chemical particle or liquid droplet with a dye applied throughout the internal thickness of the particle or droplet.

FIG. 4 is a view of a dry chemical particle or liquid droplet with smaller particles adhered to its exterior which increase the absorption of radiation to the dry chemical particle or droplet.

FIG. 5 is a view of a dry chemical particle or liquid droplet with particles that leave a residue on surrounding dry chemical particles that improve absorption of thermal radiation, and which may react exothermically.

### DETAILED DESCRIPTION

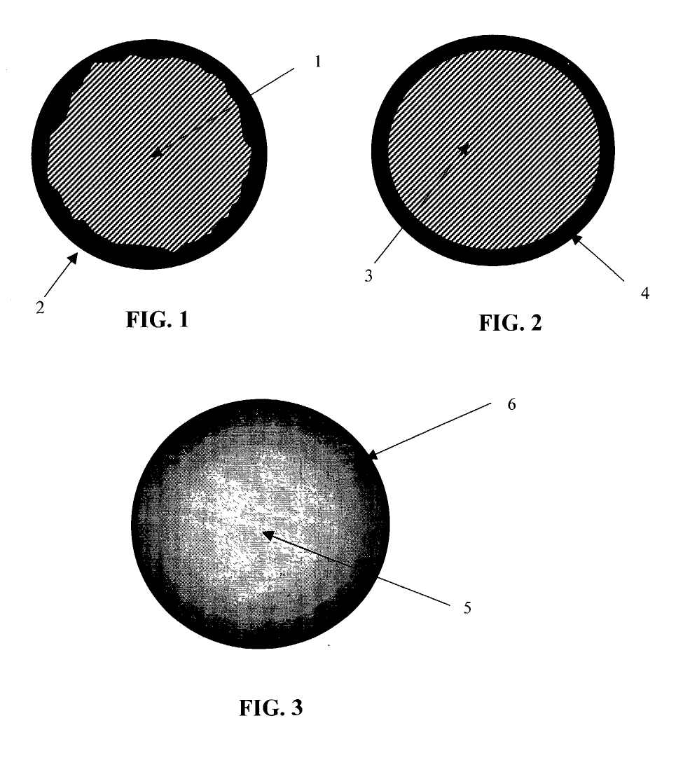

Refer to FIG. 1, a cutaway view of a dry chemical particle or liquid droplet. The particle 1 (liquid or solid) has its surface modified by a dye 2 to change its color to one more conducive to absorbing thermal radiation of the wavelengths most common to the carbon-based emission spectra and temperatures encountered in fires, as opposed to the light or white colors commonly used for dry chemical particles, which are much less effective in absorbing thermal radiation as opposed to reflecting it back to the fire itself. Many shades and colors can be used to produce this effect and improve absorption to varying degrees, although flat black will be most likely to optimally absorb radiation due to established knowledge in radiation processes. The color or shade chosen may be influenced by economic considerations, in which some colors may be produced more economically due to the cost of the dye itself, the amount of dye that must be used, the cost or complexity of the dyeing or color addition process, and other handling, storage, flow and extinguishing performance issues. As an example, many dyes are used in the food processing or printing industries that are very inexpensive, safe to handle and even digest, non-combustible and leave no undesired residue after treatment. Many of these dyes are normally applied to sodium bicarbonate in both industries, which is also a common dry chemical fire extinguishant. These dyes can be added by numerous techniques, such as wet treatment (by dissolving the particles with the liquid dye added) with the desired final powder particle sizes established by later grinding and treatment, or “dry” processes where the dye comes into contact with the dry chemical and is applied without dissolving the particles. These techniques can be applied in large batches, such as by use of jet mills. The treatment of only the outer particle surface has the advantage of using a minimal amount of dye. The increased heat absorbency will then apply as long as the outer dyed layer persists, until the modified surface evaporates during melting from heat, to whatever depth of penetration exists of the dye into the surface.

FIG. 2 is a cutaway view of a similar particle 3, with a distinct outer coating 4 applied to the particle 3. This coating 4 would be chosen for its noted ability to absorb infrared radiation, and accordingly conduct this heat into the core of the particle 3 itself. A coating could be applied by an even more diverse array of manufacturing techniques, including soaking the particles, spray drying, electrostatic techniques and many other means. This enhancement would last until the outer coating evaporated due to heating. By this time, substantial heat will have been conducted into the core of the particle. Additionally, such coatings may have favorable features of chemical inhibition of fires in their own right when decomposed, or improved handling, toxicity, cleanup and flow characteristics.

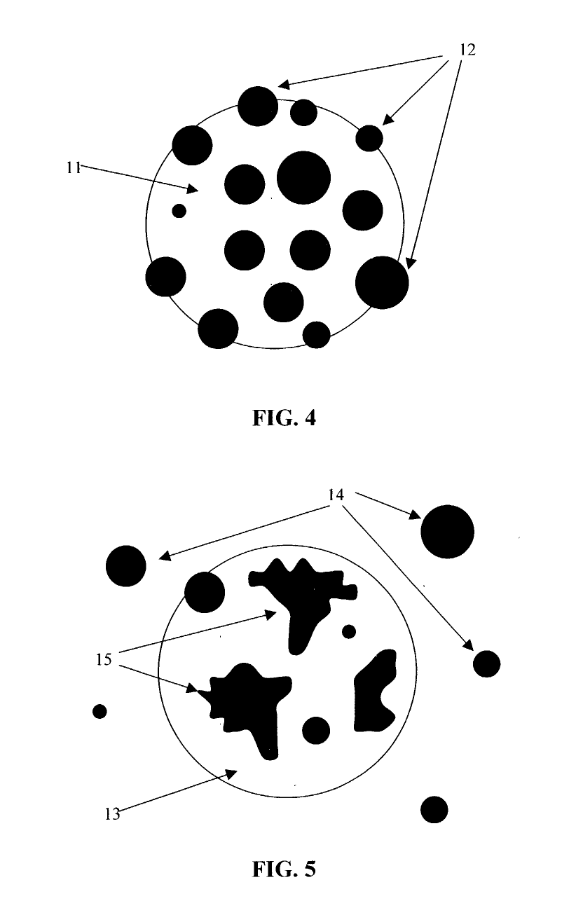

FIG. 3 is a cutaway view of a particle 5 in which a dye 6 is applied throughout all or a substantial portion of the thickness of the particle 6. More limited manufacturing techniques may be used to achieve such penetration depths of the dye into the particle; liquid “wet” methods are one way of assuring such full penetration. Such techniques may prove more expensive to provide, in terms of increased dye used and more expensing processing methods, but particles so treated may perform better in use against fires. This is because the improved radiation absorbency would persist throughout the particle melting and vaporization process, until the particle completely melts and evaporates. Of course, a liquid particle would be treated using a “wet” process, which would penetrate through the depth of the liquid particle or droplet.

Data produced to date, using preliminary exploratory techniques of dry chemical particle dyeing and treatment, have shown that fire extinguishing powders so treated have demonstrated improved performance in extinguishing realistic outdoor liquid fuel fires. This improvement was observed in terms of accomplishing extinguishing using an amount of dry chemical less than that required with untreated powder of otherwise the same makeup. Further optimization of dye or coating materials selected, treatment techniques and quantities used, should result in further improvements in performance. Variants have been used using commercially available dyes that left behind no additional difficulties in cleanup, or unwanted staining on surfaces on which the powder is deposited.

Other alternative embodiments of this technique exist, by the incorporation of additive particles that enhance such radiative adsorption. Refer to FIG. 4, a view of a dry chemical particle or liquid droplet. The particle 11 (liquid or solid) has had smaller additional particles 12 adhered to the particle's surface, which are of low cost and have increased absorptivity of thermal radiation. For example, iron oxide can be acquired at very low cost, being used for a myriad of applications, and having an absorptivity coefficient near 1.0. Such particles can be obtained in sizes on the order of 3 microns, which is much smaller an average dry chemical particle diameters of 34 microns, which would facilitate their adherence and covering of all or part of the dry chemical particle's surface, at a small fraction of the dry chemical volume and mass. These particles would absorb large quantities of thermal radiation, rather than reflect it, and conduct this heat to the dry chemical's surface. Iron oxide particles are generally considered inert in hot environments; however, if transported to a flame interior by a dry chemical particle, such iron oxide particles may decompose and deliver highly-effective iron ions to inhibit the fire chemically, further improving its effectiveness.

FIG. 5 reveals another alternative to generate the desired results. In this embodiment, inexpensive, small particles 13 are mixed with dry chemical fire extinguishing particles 14, which have a surface conducive to the absorption of thermal radiation, and leave residue 15 on surrounding dry chemical particles that retain these absorptive properties which transmit heat into the dry chemical particles. Such an inexpensive additive is activated charcoal particles, which have very high absorptivity, and leave such residue. These particles also have numerous pores that can entrap reactive species released in the fire zone to prevent their interaction in the flame. This material may also react exothermically when exposed to a sufficiently high temperature environment, generating heat which may assist in the decomposition of the surrounding dry chemical particles into beneficial chemically-reacting species such as metal ions. Other materials are available that exhibit similar properties.

There is thus described novel techniques and features to improve the performance of fire extinguishing dry chemicals or liquids, which meets all of its stated objectives and which overcomes the disadvantages of existing techniques.

The foregoing description of the preferred embodiments of the invention has been presented for purposes of illustration and description. It is not intended to be exhaustive or limit the invention to the precise form disclosed. Many modifications and variations are possible in light of the above teaching. It is intended that the scope of the invention be limited not by this detailed description, but rather by the claims appended hereto.

I claim:

1. A composition of particles, applied to heated gaseous volumes, featuring modifications to said particles to enhance their thermal radiation aborptivity.

2. The composition of claim 1, wherein said gaseous volumes are heated due to chemical reactions.

3. The composition of claim 1, wherein said particles are solid.

4. The composition of claim 1, wherein said particles are liquid.

5. The composition of claim 1, wherein said modification is due to dyeing.

6. The composition of claim 1, wherein said modification is due to applying a surface coating.

7. The composition of claim 1, wherein said modification extends to the full interior of the particles.

8. The composition of claim 1, wherein said modification extends partially through the interior of the particles.

9. The composition of claim 1, wherein said modification is performed on said particle material while in liquid form, and reconstituted to discrete particles afterwards.

10. The composition of claim 1, wherein said modification is performed on said particles while residing in discrete solid state.

11. The composition of claim 1, wherein said modification is performed using at least one of a group of modification techniques, including soaking the particles, spray drying, and electrostatic techniques.

12. The composition of claim 1, wherein said composition includes at least one from a list of substances including sodium bicarbonate, potassium bicarbonate, ammonium polyphosphate and monoammonium phosphate.

13. A composition of particles, applied to heated gaseous volumes, further including additive particles that enhance the thermal radiation aborptivity of the entire composition of particles.

14. The composition of claim 13, wherein said additive particles adhere to the other particles of the composition.

15. The composition of claim 13, wherein said additive particles leave a residue on the outer surface of other particles of the composition, said residue increasing the thermal radiation absorbed into the interior of said other particles.

16. The composition of claim 13, wherein said additive particles absorb thermal radiation that might otherwise be reflected to said gaseous volumes or to the environment.

17. The composition of claim 13, wherein said additive particles are composed of iron oxide.

18. The composition of claim 13, wherein said composition includes at least one from a list of substances including sodium bicarbonate, potassium bicarbonate, ammonium polyphosphate and monoammonium phosphate.

19. A composition of particles, applied to heated gaseous volumes, further including additive particles that react exothermically and generate heat to enhance the thermal decomposition of the entire composition of particles.

20. The composition of claim 19, wherein said additive particles are composed of activated charcoal.
